(19) United States
(12) Patent Application Publication
(10) Pub. No.: US 2005/0250504 A1
(43) Pub. Date: Nov. 10, 2005

(54) Channel setup in a wireless communication network

(75) Inventor: Juha Mikola, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/935,229

(22) Filed: Sep. 8, 2004

Related U.S. Application Data
(60) Provisional application No. 60/567,772, filed on May 5, 2004.

(51) Int. Cl. H04Q 7/20

(52) U.S. Cl. 455/450

(57) ABSTRACT

A method, user terminal and network entity sets up channels in a wireless communications network by receiving a broadcast message including at least one predefined radio configuration at a user terminal. The method also includes receiving a configuration message from a network controller at the user terminal. The configuration message includes an indication to configure the user terminal to adopt the predefined radio configuration for a new transmission channel. The method also includes indicating that the user terminal is configured to transmit data to the network controller according to the predefined radio configuration.

### REFERENCE TO RELATED APPLICATION

This application claims priority of U.S. Provisional Patent Application Ser. No. 60/567,772, filed May 4, 2004. The subject matter of the earlier filed application is hereby incorporated by reference.

### FIELD OF THE INVENTION

The present invention relates to channel setup in a wireless communications network, and particularly but not exclusively to channel state transitions and radio bearer reconfigurations.

### BACKGROUND OF THE INVENTION

In current wireless communications networks, a number of radio resource (RRC) messages are utilised for different channel state transitions and radio bearer reconfigurations. For example, a cell update confirm message is used to move a user equipment from a paging channel state (Cell/URA_PCH) to a forward access channel state (Cell_FACH). A radio bearer reconfiguration message is used to move a user equipment (UE) from a forward access channel state to a dedicated channel state (Cell_DCH). A radio bearer reconfiguration message is also used to reconfigure radio bearers when in the dedicated channel state.

Many applications need to transmit data when the user equipment is in the forward access state or paging channel state. The transition time to a dedicated channel state which allows transmission of the data is often one of the major factors that influences user performance. This is particularly evident for higher data rates, where the transmission time of the data is decreased but the transition time to the dedicated channel state remains the same. Also, even if the user equipment is in the dedicated channel state, the data rate may need to be changed and this requires radio resource control (RRC) signalling, which is time consuming.

### SUMMARY OF THE INVENTION

It is one aim of the present of the present invention to reduce the time for RRC state transitions and to reconfigure radio bearers. Another aim is to improve the reliability of RRC signalling.

According to one aspect of the present invention there is provided a method of setting up channels in a wireless communications network comprising the steps of: receiving at a user terminal a broadcast message including at least one predefined radio configuration; receiving at the user terminal a configuration message from a network controller, said configuration message comprising an indication to configure the user terminal to adopt the at least one predefined radio configuration for a new transmission channel; and indicating to the controller that the user terminal is configured to transmit data according to the predefined radio configuration.

A further aspect of the invention provides a user terminal for use in a wireless communications network comprising: means for receiving a broadcast message including at least one predefined radio configuration; a store for storing said at least one predefined radio configuration; means for receiving a configuration message from a network controller, said configuration message comprising an indication to configure the user terminal to adopt the at least one predefined radio configuration for a new transmission channel; and means for accessing said at least one predefined radio configuration from the store and configuring a new transmission channel in accordance with the predefined radio configuration.

Another aspect provides a network entity for use in a wireless communications network, the network entity comprising: means for transmitting to a plurality of user terminals in the network a broadcast message including at least one predefined radio configuration; and means for transmitting a configuration message comprising an indication to configure one of said user terminals to adopt the at least one predefined radio configuration for a new transmission channel.

By arranging for at least one predefined radio configuration to be transmitted in a broadcast message, the message size of the configuration message can be reduced so that it can be carried over the air interface more quickly and more reliably. In the described embodiment, the configuration message is a radio resource control (RRC) message, for example in accordance with release 6 or the 3GPP specification for the UMTS (Universal Mobile Telecommunication Service) terrestrial radio access (UTRA).

For a better understanding of the present invention and to show how the same may be carried into effect reference will now be made by way of example to the accompanying drawings.

### BRIEF DESCRIPTION OF THE DRAWINGS

FIG. 1 is a schematic diagram illustrating a signalling exchange to implement a state transition;

FIG. 2 is an alternative signalling sequence for the state transition shown in FIG. 1;

FIG. 3 illustrates a signalling sequence for a state transition between a forward access channel state and a dedicated channel state;

FIG. 4 illustrates a signalling sequence for reconfiguring a radio bearer in a dedicated channel state;

FIG. 5 is a schematic diagram of an existing RRC message structure;

FIG. 6 is a schematic diagram of a compressed RRC message structure in accordance with one embodiment of the present invention; and

FIG. 7 is a schematic diagram illustrating the concept underlying the present invention.

### DETAILED DESCRIPTION

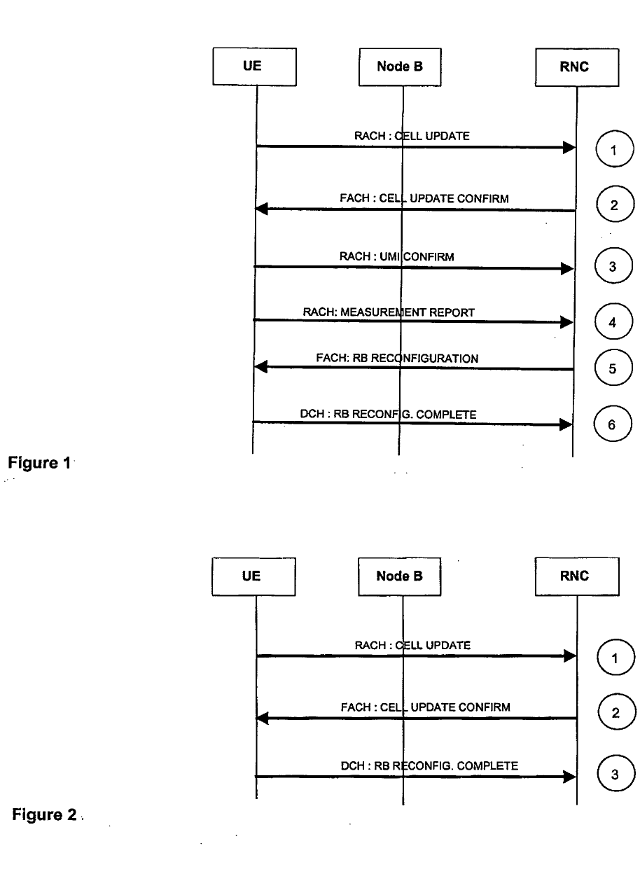

FIG. 1 illustrates a sequence of steps between a user equipment (UE) and a radio network controller (RNC) in a wireless communications network. As is known, a user equipment in the form of a mobile terminal such as a mobile telephone or other mobile station communicates with a Node-B or base station in a cellular communications network via a radio interface and in particular using radio channels. The Node-B communicates with a radio network controller which manages one or more Node-Bs either via a fixed or wireless interface and transfers information from the user equipment (UE) to the radio network controller (RNC) and returns control messages, acknowledgements and data. The sequence illustrated in FIG. 1 is the normal signalling sequence for transferring a user equipment (UE) from a paging channel state to a forward access channel state. These states are referred to herein as Cell/URA_PCH and Cell_FACH respectively. In a paging channel mode, the user equipment (UE) is merely advising its presence to the network and is not in a position to send or receive significant quantities of data. In order to transmit data, it needs to move to a Cell_FACH state. If the amount of data to be transferred exceeds a certain threshold, the forward access channel is no longer an appropriate channel to use, and in that case a dedicated channel DCH is required.

As illustrated in FIG. in 1, in step 1 the user equipment sends a cell update message over a radio access channel to indicate that it has uplink data available to transmit. In step 2, the radio network controller responds by transmitting a cell update confirm message which acknowledges the cell update message and instructs the user equipment to enter a Cell_FACH state, where data transmission is possible. In step 3, the user equipment transmits a UTRAN (Universal Telecommunications Radio Access Network) mobility information confirm message (UMI CONFIRM) to acknowledge the cell update confirm message. It is now possible for the user equipment to transmit data on the radio access channel, that is it is in the Cell_FACH state. If the available amount of data (traffic volume) is above a configured threshold, the user equipment transmits a measurement report to inform the radio network controller (RNC) about the available amount of data as indicated in step 4. When the radio network controller receives a measurement report it can decide to move the user equipment over to a dedicated channel, Cell_DCH state, since the radio access channel has very limited performance. The radio network controller sends a radio bearer reconfiguration message in step 5 which instructs the user equipment to move to a dedicated channel. The user equipment responds with a radio bearer reconfiguration confirm message in step 6 which acknowledges the received message and indicates that the user equipment has entered the Cell_DCH state and is ready to transmit data on the dedicated channel.

FIG. 2 illustrates a truncated sequence of events for achieving the same result as in FIG. 1. In FIG. 2, in response to the cell update confirm message (step 12) returned by the radio network controller the user equipment moves immediately into a dedicated channel state and responds with a radio bearer reconfiguration complete message in step 13. The user equipment can then start to transmit data on the dedicated channel. The respective steps are denoted 11, 12 and 13 in FIG. 2.

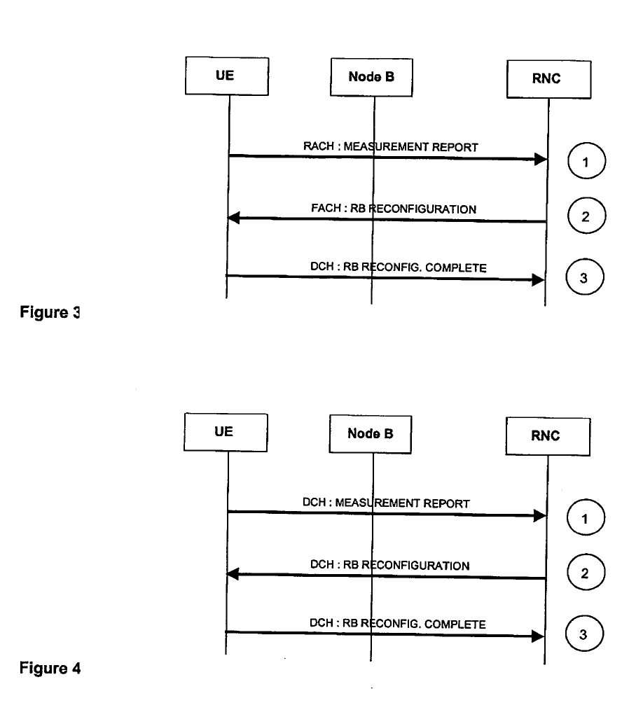

FIG. 2 shows a signalling sequence for moving a user equipment from the paging channel state directly to the dedicated channel state. FIG. 3 shows a signalling sequence where the user equipment is already in the forward access channel state and it is moved from that state to the dedicated channel state. In FIG. 3, step 21 shows the transmission of a measurement report informing the radio network controller about the available amount of data (step 21). The radio network controller responds with a radio bearer reconfiguration message (step 22). The user equipment responds with a radio bearer reconfiguration confirm message in step 23 indicating that the user equipment has entered the dedicated the channel state and is ready to transmit data on the dedicated channel.

FIG. 4 illustrates a signalling sequence for reconfiguring a radio bearer which is already in the dedicated channel state. In that case, step 31 denotes the transmission of a measurement report over the dedicated channel from the user equipment to the radio network controller. Step 32 illustrates a radio bearer reconfiguration message transmitted from the radio network controller (RNC) to the user equipment (UE). The user equipment acknowledges the message with a radio bearer reconfiguration complete message on the dedicated channel, indicating that the dedicated channel has been reconfigured in accordance with the new transmission requirements to deal with the information in the measurement report.

The messages exchanged between the user equipment and the radio network controller to achieve the changes in channel state discussed above are referred to herein as radio resource control (RRC) messages. RRC signalling (the exchange of RRC messages) represents a significant part of the time required to set up a call. RRC messages comprise information elements containing generally applicable information (common to all dedicated channels is a cell or network, and specific information, specific to a particular channel.

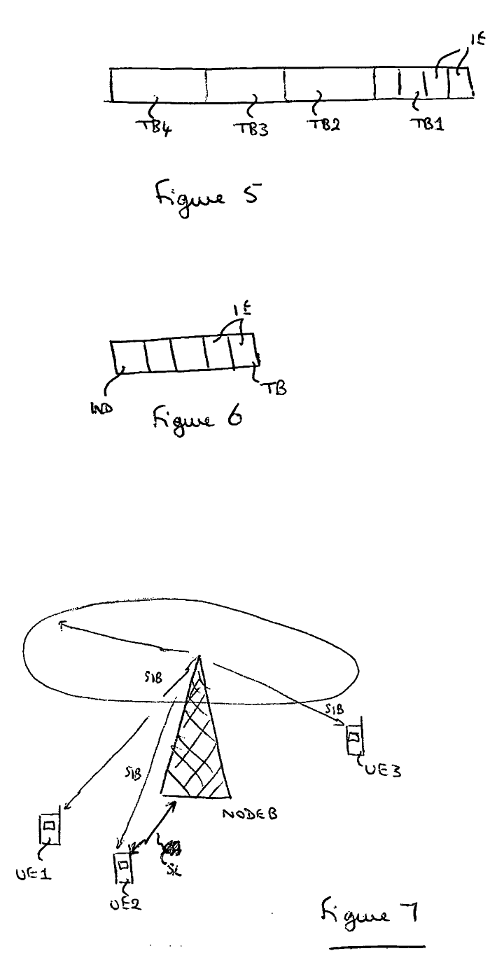

FIG. 5 illustrates one example, being a radio bearer reconfiguration message. This message comprises four transport blocks TB1 . . . TB4, each transport block comprising one or more information elements i.e. assume that transport block 1 includes information elements of the type just mentioned which are unique to a particular message or channel, whereas transport blocks TB2 to TB4 include “general” information elements.

According to the described embodiment of the invention, the information elements lEs representing common network information is broadcast to users in a particular cell from the Node-B for that cell, rather than being conveyed in each of the RRC messages during an RRC signalling exchange. This information already exists in system information block 16 (SIB 16). This information could be broadcast in an extension to SIB 16, or in a new SIB. The extended SIB or new SIB would broadcast predefined configurations for the most common radio bearers used in the network. Whenever the radio network controller (RNC) wished to establish a new dedicated channel to a user equipment, all general information elements are deleted and an indicator identifying one of the predefined configurations indicated by the SIB would be included. Information elements that are not general remain in the RRC message itself. An example structure of an existing SIB is given in 3GPP TS 25.331 Chapter 13.7.

FIG. 6 shows such a truncated RRC message which consists of a single transport block (TB) which has a number of information elements specific to that particular user and an indicator of a predefined or default radio configuration which has already been broadcast using the SIB.

FIG. 7 is a schematic diagram illustrating the concept underlying the present invention. A Node-B is illustrated which is implementing a broadcast transmission including a system information block (SIB) to a number of users UE1, UE2, UE3 in a cell of a cellular communications network. In addition, a dedicated signalling link is established between one of the user equipments UE2 and the Node-B. This signalling link is labelled SL and is intended to denote a dedicated link for communications between the Node-B and the user equipment UE2 as distinct from the broadcast transmission of the SIB. Of course, the user equipment UE2 will also receive the broadcast transmission and so will have the general information which it needs to implement instructions which are received over the signalling link (SL), in particular RRC messages of the type discussed above with reference to FIGS. 2 to 4.

Predefined or default configurations which are broadcast to the user equipment (UE) are stored at the user equipment in a memory so that they are ready for use when instructed by an RRC message. According to the described embodiment of the present invention, predefined or default configurations are defined for the cell update confirm message and the radio bearer reconfiguration message.

The above described embodiment of the present invention provides a number of advantages. The cell update confirm message can be used to move the user equipment directly from the paging state to the dedicated channel stage (FIG. 2), and thus reduces the transition time with respect to the normal signalling exchange (FIG. 1) for this change of state.

Where a radio bearer reconfiguration message is used to move the user equipment from the forward access channel state to the dedicated channel state, or to reconfigure the radio bearers in the dedicated channel state, use of the above described compressed RRC message reduces the time to take the new configuration into use. This is because the time taken to transmit the truncated RRC message (FIG. 6) is significantly less than the time which would have been taken to transmit the whole RRC message. In addition, RRC signalling is more reliable and the RRC signalling load over the air interface is reduced.

The invention can also be implemented in a voiceover internet protocol (VoIP) call where at RAB setup, the RAB data rate is configured to accommodate the transmission of RTP (Transport Protocol for Real-time Applications) packets with uncompressed headers. This RAB rate is used in the initial phase until ROHC (Robust Header Compensation) can compress the headers. At that point, the RAB data rate is reconfigured to a rate suitable for transmission of RTP packets with compressed headers. In the case uncompressed headers need to be transmitted, the RAB data rate is again reconfigured and adapted to the transmission of uncompressed headers.

As an alternative to transmitting predefined radio configuration using an SIB, a default configuration could be hard coded into the mobile terminal. In that case, the RRC message could include an indication that the default configuration is to be utilised for the channel.

1. A method of setting up channels in a wireless communications network, the method comprising the steps of:
receiving a broadcast message including at least one predefined radio configuration at a user terminal;
receiving a configuration message from a network controller at the user terminal, said configuration message comprising an indication to configure the user terminal to adopt the at least one predefined radio configuration for a new transmission channel; and
indicating to the network controller that the user terminal is configured to transmit data according to the predefined radio configuration.

2. A method according to claim 1, wherein the configuration message comprises a cell update confirm message for which the predefined radio configuration for transmission of the data defines a dedicated channel.

3. A method according to claim 1, wherein the configuration message comprises a radio bearer reconfiguration message responsive to a data transmission request from the user terminal including a measurement report.

4. A method according to claim 3, further comprising transmitting the radio bearer reconfiguration message over a forward access channel from the network controller to the user terminal.

5. A method according to claim 3, further comprising transmitting the radio access bearer reconfiguration message over a dedicated channel from the network controller to the user terminal.

6. A method according to claim 3, further comprising requesting reconfiguration of a transmission channel from a paging channel to a dedicated channel in the data transmission request.

7. A method according to claim 1, wherein the data transmission request includes a request to change a transmission channel from a forward access channel to a dedicated channel.

8. A method according to claim 1, wherein the at least one predefined radio configuration includes data defining a data rate for transmission of packets.

9. A method according to claim 1, further comprising selecting one of a plurality of predefined radio configurations for the new transmission channel according to the indication in the configuration message, wherein the broadcast message comprises the plurality of predefined radio configurations.

10. A method according to claim 1, wherein the broadcast message comprises a system information block including said at least one predefined radio configuration.

11. A method according to claim 1, further comprising a step of storing said at least one predefined radio configuration at the user terminal for use on receipt of the configuration message.

12. A user terminal for use in a wireless communications network, the user terminal comprising:
means for receiving a broadcast message including at least one predefined radio configuration;
a store for storing said at least one predefined radio configuration;
means for receiving a configuration message from a network controller, said configuration message comprising an indication to configure the user terminal to adopt the at least one predefined radio configuration for a new transmission channel; and
means for accessing said at least one predefined radio configuration from the store and configuring the new transmission channel in accordance with the predefined radio configuration.

13. A network entity for use in a wireless communications network, the network entity comprising:
means for transmitting a broadcast message including at least one predefined radio configuration to a plurality of user terminals in a network; and
means for transmitting a configuration message comprising an indication to configure one of said plurality of user terminals to adopt the at least one predefined radio configuration for a new transmission channel.

14. A network entity according to claim 13, the network entity comprising a Node-B.

15. A network entity according to claim 13, the network entity comprising a base station.

16. A network entity according to claim 13, further comprising means for receiving said at least one predefined radio configuration from a network controller for transmission to said plurality of user terminals in said broadcast message.

17. A method of setting up channels in a wireless communications network comprising the steps of:
storing at least one default configuration at a user terminal;
receiving a configuration message from a network controller at the user terminal, said configuration message comprising an indication to configure the user terminal to adopt the at least one default configuration for a new transmission channel; and
indicating to the network controller that the user terminal is configured to transmit data according to the at least one default radio configuration.

18. A user terminal for use in a wireless communications network, the user terminal comprising:
a store holding at least one default radio configuration;
means for receiving a configuration message from a network controller, said configuration message comprising an indication to configure the user terminal to adopt the at least one default radio configuration for a new transmission channel; and
means for accessing said at least one default radio configuration from the store and configuring a new transmission channel in accordance with the at least one default radio configuration.
